(19) United States
(12) Patent Application Publication
(10) Pub. No.: US 2026/0222387 A1
(43) Pub. Date: Jul. 30, 2026

(54) FACILITATING SECURE, SCALABLE, SEGMENTED LAYER TWO COMMUNICATIONS

(71) Applicant: Capital One Services, LLC, McLean, VA (US)

(72) Inventors: Rory Gallagher Murray, McLean, VA (US); Syed Shah, Mckinney, TX (US); Daniel James McDavid, Richmond, VA (US)

(73) Assignee: Capital One Services, LLC, McLean, VA (US)

(21) Appl. No.: 19/039,746

(22) Filed: Jan. 28, 2025

(51) Int. Cl. H04L 9/40

(52) U.S. Cl. CPC H04L 63/0263; H04L 63/0236; H04L 63/0272; H04L 12/4666; H04L 63/162

(57) ABSTRACT

Methods and systems are described herein for reducing data storage requirements associated with facilitating secure, scalable, segmented layer two communications. For example, the system may receive a message, from a first device, at a first port mapped to a first Virtual Local Area Network (VLAN), to communicate with a second device. The system may insert, based on receiving the message, a Security Group Tag (SGT) into the message. The system may determine a second port, and in response to determining, based on an assigned SGT to the second port, that a second VLAN is different than the first VLAN, the system may: forward the message to an enforcement point. The system may verify, at the enforcement point, whether the network traffic between the first and second device is valid. In response to the network traffic being valid, the system may forward the message to a gateway address.

### BACKGROUND

The Open Systems Interconnection (OSI) model is a framework that separates network communication functions into seven layers each having their own responsibilities. The OSI model encapsulates each type of network communication across a variety of hardware and software components to enable one or more systems to communicate via standardized interfaces or protocols. Each layer may work together to transmit information from one device to another device.

### SUMMARY

Methods and systems are described herein for novel uses and/or improvements to network communications. As one example, methods and systems are described herein for reducing data storage requirements associated with facilitating secure, scalable, segmented layer two communications.

To facilitate communications within computing networks, network engineers may segment a computing network where primary devices of a given type are placed into a Virtual Local Area Network (VLAN) segment. For instance, a first VLAN segment may include a set of printers and a second VLAN segment may include a set of laptop computers. However, to implement this, secondary devices that facilitate communication between the primary devices, such as network switches and routers may also be part of, or interact with, the respective VLAN segments. Given the high cost of these components, such secondary devices may be part of one or more segments. For example, a single switch may be part of the first VLAN segment and the second VLAN segment to enable communication between a laptop of the second VLAN segment and a printer of the first VLAN segment. Physically speaking, although the secondary devices may be part of one or more VLAN segments, the natural configuration of the VLAN prohibits communication between one VLAN segment and another VLAN segment without special permissions. Segmenting the network in this fashion may help network engineers diagnose errors when they arise due to primary device types being segmented into their respective VLANs. Additionally, segmenting the network using VLANs may also improve cybersecurity of the network as only components that are part of a VLAN may communicate with one another without special permissions. However, enabling communication between devices within the same segment inherently leaves communication within a given VLAN segment susceptible to security vulnerabilities.

For instance, the natural configuration of a VLAN enables each device that is part of a VLAN to communicate with each other. Intuitively, this does not cause one to believe that a security vulnerability exists, counterintuitively, however, in large entity computing networks, devices of the same type communicating with one another may be indicative of a cyber security attack. For example, where a VLAN segment comprises a set of printers, a first printer communicating with a second printer is a suspicious communication given that a printer traditionally receives a request to print from a device of another type (e.g., a laptop) as opposed to another device of the same type (e.g. another printer). To overcome this, network engineers may utilize Private Local Area Networks (PVLAN) in lieu of VLANs to prevent devices of the same type from communicating with one another. For example, a PLVAN's natural configuration prevents devices within the same PVLAN from communicating with one another, while only enabling communication between primary and secondary devices. However, PVLAN technology is not scalable and is outdated. For example, PVLAN technology has limited device support. As another example, as the number of network segments increase, segmenting a network based on PVLAN technology requires a large amount of network switches as peer-to-peer device communication within a PVLAN is prohibited, requiring a central uplink to facilitate communication between devices when switch ports are all exhausted. Moreover, due to the broadcasting protocols involved with PVLAN technology, learning MAC addresses for devices within a PVLAN causes instability within the network when devices are onboarded to a PVLAN segment (e.g., due to the centralized uplink requirements).

In recent years, however, the advent of SGT (Security Group Tags) has offered a solution to the pitfalls of PVLAN technology. For example, each device within a computing network may be assigned a SGT. In conjunction with Access Control Lists (ACLs), network engineers may use these SGTs with the ACLs to create Access Control matrices that define allowable traffic flows between one device to another. For instance, the Access Control matrix may be an N×N matrix, where N represents respective SGTs, and the inner portion of the matrix indicates whether communication is approved or denied between devices having a given SGT combination. While leveraging Access Control matrices offer control as to which devices may communicate with each other, such Access Control matrices are manually created by network engineers and require a large amount of computer memory to store the approved and denied communications between devices within a network. For instance, as networks may comprise hundreds of thousands of IoT devices, the Access Control matrix must account for each relationship to ensure that unauthorized communications are not permitted. As such, a computing network using this implementation experiences increased network latency as data sent between two devices must (i) pass through a firewall implementing the Access Control Matrix and (ii) verify whether communication is permitted. Additionally, such implementation also increases the amount of computing processing power at the firewall as such communication must be verified by accessing the Access Control Matrix, comparing SGT tags of the devices that are to communicate, and either allowing or denying such communication based on the Access Control Matrix.

To overcome the technical disadvantages of these existing systems, methods and systems described herein facilitate a reduction in data storage requirements associated with facilitating scalable, secure, segmented layer two communications. For example, the system may receive a message, from a first device, at a first port mapped to a first VLAN, to communicate with a second device. For instance, a first primary device may attempt to communicate with a second primary device. To facilitate this communication, one or more secondary devices (e.g., network switches, routers, etc.) may be involved to enable messages (or other information) to be transmitted between the primary devices. The first primary device may transmit information (e.g., the message) that is intended to be received at the second primary device. The message may include a first address associated with the first device and a second address associated with the second device. However, to increase networking security, the computing network in which these devices rely on for communication may be segmented into one or more VLANs. For example, each VLAN that is part of the computing network may group primary devices that share a common characteristic (e.g., device type) together. However, as described above, the inherent nature of VLANs enable unrestricted communication between devices within a given VLAN, and only exclude direct communication between primary devices of different VLANs—thereby leading to numerous security vulnerabilities. As one example, where a VLAN is related to a group of printers, one printer of that VLAN communicating with another printer of that VLAN may be indicative of a cybersecurity attack (as under normal operation, printers need not communicate with one another to fulfil a print job). Moreover, given that the nature of VLANs allow such unrestricted communication between devices within the given VLAN, if a primary device of that VLAN is compromised, an attacker may gain access to all devices part of that VLAN to implement a cyber security attack.

As discussed above, while leveraging PVLAN technology in place of VLAN technology, PVLAN may, on its surface, be a great solution to secure communications within the VLAN, PVLAN technology prevents scalability as PVLAN offers minimal device support and creates broadcasting storms (e.g., increased network traffic) when learning Media Access Control (MAC) addresses of the devices to effectively communicate. To overcome this, the system may nonetheless use VLAN technology by segmenting the computing network into a set of segments where the primary devices that are part of a respective VLAN share a common characteristic. When combined with a unique implementation of SGTs, the system may reduce data storage needs conventionally associated with generating ACLs to control valid network traffic flows among primary devices within and across VLANs. To do so, based on the system receiving a message (e.g., from a first device to communicate with a second device), the system may insert a SGT into the message. For example, the system may insert the SGT assigned to the port at which the message was received. For instance, a network switch may be configured (e.g., via a configuration profile) to update received messages at a given port to include the SGT assigned to that port. Because the ports of the network switch are configured to receive messages or other information directly from the primary devices, and because SGTs are associated with a given VLAN (e.g., one SGT per VLAN), the system is able to identify which VLAN the device belongs to in real time. Moreover, by inserting the SGT into the message, as will be described later, if the message is forwarded to an enforcement point, the enforcement point may be made aware of which VLAN the device transmitting (e.g., sending) the message to another device is part of in order to further validate/invalidate the communication.

The system may then determine, based on the second address of the message (e.g., a destination address, a MAC address, or other address that indicates a device intended to receive the message), a second port to forward the message to be received by the second device. For example, the second port may be mapped to a second VLAN. In response to determining, based on an assigned SGT to the second port, that the second VLAN is different than the first VLAN, the system may forward the message, via the second port, to an enforcement point in lieu of preventing forwarding of the message based on the second VLAN being the same as the first VLAN. For example, as opposed to relying on a network engineer's creation of ACLs to define valid network traffic flows between one or more primary devices, the system may rely on port-based configuration of VLANs and the SGTs associated with such VLANs to determine whether the message shall be prohibited from being forwarded to second primary device (e.g., in the case where the SGT inserted into the message matches the assigned SGT of the second port) or permitted to be forwarded (e.g., in the case where the SGT inserted into the message fails to match the assigned SGT of the second port) to the enforcement point to further verify whether the network traffic flow is valid. That is, as opposed to relying on a non-easily-scalable and large Access Control matrices defining valid network traffic flows, the system instead relies on a single “rule” that is based on a match or mismatch between given SGT's. In this way, the system reduces data storage requirements to implement secure, scalable, segmented layer two communications within a computing network at the segment-level. Moreover, in this way, the system balances (i) the security benefits of PVLAN technology by effectively implementing a PVLAN network segment using SGTs and (ii) preserving the scalable nature of VLAN technology.

However, while such unique implementation of SGTs and VLAN technology may improve segment-level cybersecurity, securing the computing network across the different VLANs presents its own challenges. For example, as described above, given the high cost of secondary devices (e.g., network switches), such secondary devices may be part of multiple VLANs. However, due to VLAN technologies'natural configuration, primary devices that are not part of the given VLAN are prohibited (or otherwise disabled) from communicating with one another. In such implementation of the segmented network based on VLAN technology, the need arises for those primary devices that are part of differing VLANS to communicate with one another. However, by simply implementing a “rule” or other special permission to enable this communication when SGTs are different may not suffice to secure the computing network across the differing VLANs. For example, if a primary device (or secondary device) becomes compromised, the threat of a cybersecurity attack still exists. Such cybersecurity attack can involve one primary device attempting to communicate with another primary device that has valuable resources to gain control of the system.

To overcome this the system may then verify, at the enforcement point, based on one or more network traffic policies, that network traffic between the first device and the second device is valid. For example, as opposed to simply forwarding the message to the second device because the devices may be part of different VLANs (e.g., based on the inserted SGT at the first port failing to match the assigned SGT of a second port), the system may verify at the enforcement point whether the network traffic communication (e.g., network traffic flow) is valid. For instance, the enforcement point may be a network router (e.g., layer three network router) that is associated with a managing firewall with one or more network traffic policies. The enforcement point may determine network traffic validity based on a variety of factors such as SGTs, device type/category, direction of network traffic flow (e.g., from which device, to which device, etc.), temporal based network traffic factors, or other network traffic policies. In response to the network traffic between the first device and the second device being valid, the system may cause forwarding of the message to a gateway address associated with communicating with the second device. For example, the gateway address may be an IP address associated with a network router to facilitate communication between the different VLANs. By doing so, not only is the system able to facilitate communications between different VLANs, but the system is also able to improve security of the computing network by adding a second layer of security that is between the differing VLANs. Moreover, such implementation enables computing networks as a whole to be scalable while mitigating cybersecurity vulnerabilities as whether the network traffic is between primary devices of a given VLAN, or between primary devices of differing VLANs.

In some aspects, methods and systems for reducing data storage requirements associated with facilitating scalable, secure, segmented layer two communications are described. For example, the system may receive a message, from a first device, at a first port mapped to a first VLAN, to communicate with a second device, where the message comprises a first address associated with the first device and a second address associated with the second device. The system may insert, based on receiving the message at the first port mapped to the first VLAN, a SGT that is assigned to the first port into the message. The system then determines, based on the second address of the message, a second port to forward the message to be received by the second device, where the second port is mapped to a second VLAN. In response to determining, based on an assigned SGT to the second port, that the second VLAN is different than the first VLAN, the system may forward the message, via the second port, to an enforcement point in lieu of preventing forwarding of the message based on the second VLAN being the same as the first VLAN. The system may then verify, at the enforcement point, based on one or more network traffic policies, that network traffic between the first device and the second device is valid. In response to verifying that the network traffic between the first device and the second device is valid, the system may cause forwarding of the message to a gateway address associated with communicating with the second device.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a segmented computing network with shared computing resources, in accordance with one or more embodiments.

FIG. 2 shows an illustrative diagram of communicating a message between primary devices of a computing network using SGT-based and enforcement point-based communication control, in accordance with one or more embodiments.

FIG. 3 shows illustrative components for a system used to reduce data storage requirements associated with facilitating secure, scalable, segmented layer two communications, in accordance with one or more embodiments.

FIG. 4 shows a flowchart of the steps involved in reducing data storage requirements associated with facilitating secure, scalable, segmented layer two communications, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

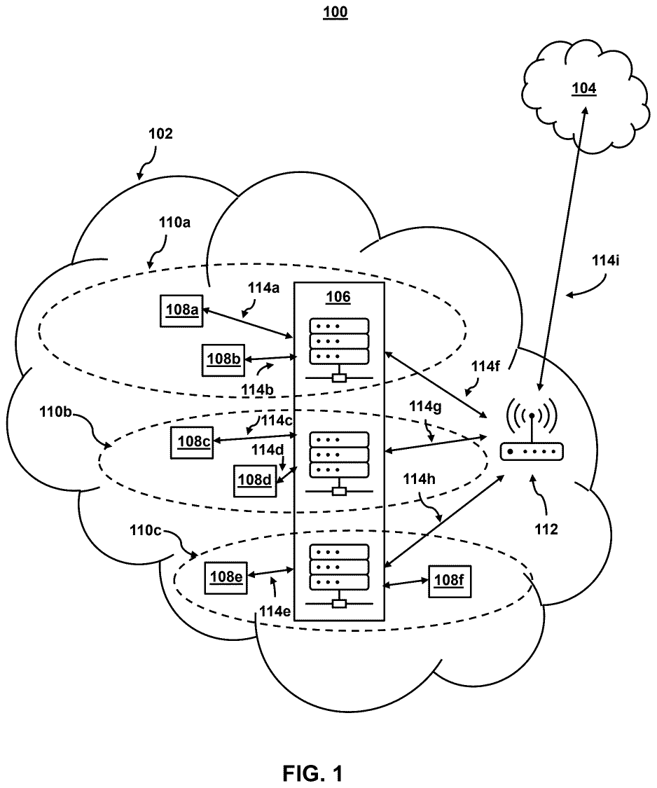

FIG. 1 shows an illustrative diagram of a segmented computing network with shared computing resources, in accordance with one or more embodiments. For example, environment 100 may indicate a segmented computing network with shared computing resources that facilitate a reduction in data storage requirements associated with facilitating secure, scalable, segmented layer two communications. For example, FIG. 1 shows Local Area Network (LAN) 102, Wide Area Network (WAN) center 104, network switch 106, computing device 108 (or computing devices 108a-108f), Virtual Local Area Network (VLAN) 110 (or VLANs 110a-110c), router 112, and communication link 114 (or communication links 114a-114i). For example, LAN 102 may be segmented into a set of VLANs 110a-110c, where one or more VLANs 110a-110c share a computing resource (e.g., network switch 106). It should be noted however, that in some embodiments, each VLAN 110a-110c may share the network switch 106 (e.g., the network switch 106 may be part of each VLAN 110a-110c). In other embodiments, however, no VLAN 110a-110c may share the network switch 106 (e.g., a unique network switch 106 may be part of each respective VLAN 110a-110c). In yet other embodiments, a first subset of VLANs 110a-110c may share a network switch (e.g., network switch 106 may be shared between first VLAN 110a and second VLAN 110b) and a second subset of VLANs may share another network switch (e.g., third VLAN 110c may have its own network switch 106). Additionally, it should be noted, that more or less of the components (e.g., LAN 102, WAN center 104, network switch 106, computing devices 108a-108f, VLANs 110a-110c, router 112, or communication links 114a-114i) described above within environment 100 may exist, but are not shown for sake of brevity.

LAN 102 may include first VLAN 110a, second VLAN 110b, and third VLAN 110c. For example, to segment a computing network, the computing network may be segmented into a set of VLANs (e.g., VLANs 110a-110c). By doing so, network engineers may benefit from having a logically separated set of subnetworks to diagnose network-related errors or help control communication between devices in the network. Each VLAN 110 may include a set of computing devices 108a-108f. For example, first VLAN may include first computing device 108a and second computing device 108b, second VLAN may include third computing device 108c and fourth computing device 108d, and third VLAN 110c may include fifth computing device 108e and sixth computing device 108f. In some embodiments, computing device 108a-108f may be considered as “primary devices,” as will be discussed in detail later. To facilitate communication between computing devices 108a-108f, one or more secondary devices may be used. For example, network switch 106 and router 112 may be considered “secondary devices,” as will be explained later.

Each of the components of environment 100 may communicate with one another via communication links 114a-114i. For example, communication links 114a-114i may include wired or wireless communication paths, such as a satellite path, a fiber-optic path, a cable path, a path that supports Internet or Intranet communication, free-space connections (e.g., for broadcast or other wireless signals), or any other suitable wired or wireless communication path or combination of communication paths. Additionally, each of the components of environment 100 may include hardware/software that enable communication among communication links 114a-114i.

While WAN center 104 is shown, it should be noted that a WAN may comprise one or more LANs. For example, LAN 102 may be one of many LANs that are interconnected via WAN center 104 to be implemented as a WAN. As discussed above, environment 100 is illustrative in nature to be in accordance with one or more embodiments. As such, other LANs, WANs, or components may exist within environment 100, although not shown.

In accordance with one or more embodiments, environment 100 shows a computing network environment involving a segmented computing network at the LAN level. For example, LAN 102 may be a segmented computing network. LAN 102's network may be segmented into first VLAN 110a, second VLAN 110b, and third VLAN 110c, where each VLAN comprises a set of computing devices 108a-108f that share a common characteristic. For instance, first computing device 108a and second computing device 108b may be printers. Third computing device 108c and fourth computing device 108d may be laptop computers. Fifth computing device 108e and sixth computing device 108f may be telephones. While segmenting the computing network into VLANs corresponding to a device type (e.g., printer, laptop, telephones, etc.) may be one way of segmenting the network, other device characteristics may exist. For example, each VLAN 110a-110c may be associated with a group of users, an access time (e.g., a time at which such components are available to be accessed), a group of devices running a given software program or version of a software program, or other characteristics.

As shown in FIG. 1, first VLAN 110a, second VLAN 110b, and third VLAN 110c may share network switch 106. For example, as described above, due to the high cost associated with network switches, network switches may be shared between one or more VLANs 110a-110c. However, due to the natural configuration of network switches leveraging VLAN technology, computing devices 108a-108f are prohibited (or otherwise disabled from communicating) with computing devices 108a-108f that are part of a different VLAN, although the network switches may “live on” or otherwise be part of multiple VLANs physically. For example, the configuration of network switches utilizing VLAN technology are automatically configured to reject communication between devices of different VLANS due to port assignments. For example, first computing device 108a and second computing device 108b are prohibited from communicating directly, via the network switch, with third computing device 108c and fourth computing device 108d. By doing so, the network is able to isolate network traffic to a given VLAN to improve cybersecurity among the segmented network.

However, when implementing such networks using VLAN technology, while the network switch 106's configuration helps isolate network traffic to be within a VLAN 110a-110c, and thereby improve cybersecurity at the segment level, computing devices of VLANs 110a-110c in some cases must be able to communicate with each other. For example, where third computing device 108c (e.g., a laptop) is to send a message indicating a document to be printed at first computing device 108a (e.g., a printer), the need exists for communication between the first VLAN 110a and the second VLAN 110b. However, given the configuration of the network switch 106, while network switch 106 is physically part of both VLANs, the network switch 106 is logically separated from facilitating communication between the first computing device 108a and the third computing device 108c. To enable secure communications across devices of first VLAN 110a and second VLAN 110b, the network traffic between the third computing device 108c and the first computing device 108a may be routed to router 112. For example, router 112 may be associated with an enforcement point, such as a firewall, that is further associated with one or more network traffic policies indicating valid network traffic flows.

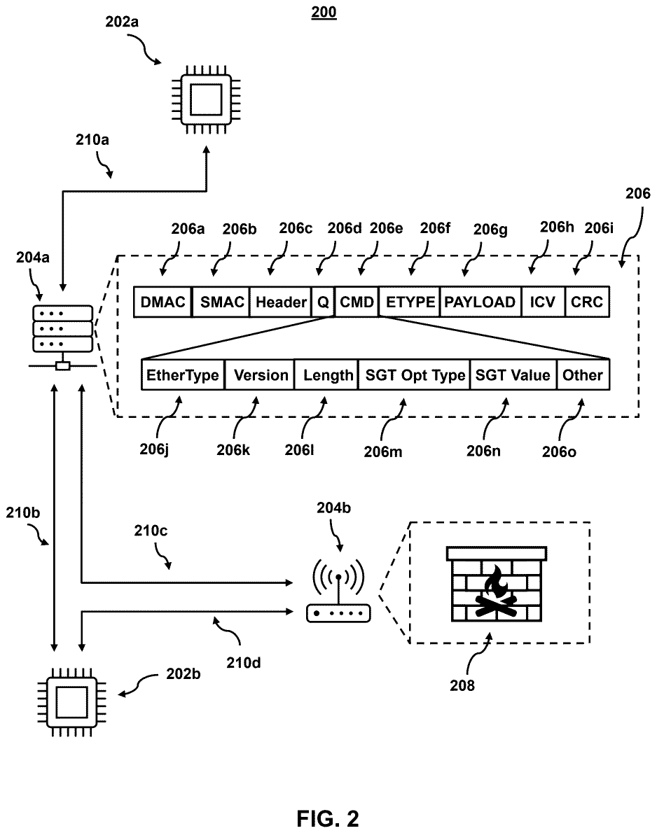

As will be described in relation to FIG. 2, for example, if a computing device (e.g., third computing device 108c) is part of a given VLAN (e.g., second VLAN 110b, determined based on based on port-based assignment of SGTs at the network switch 106) and is attempting to communicate with another computing device (e.g., first computing device 108a) that is part of a different VLAN (e.g., first VLAN 110a, determined based on port-based assignment of SGTs at the network switch 106), then the system (e.g., network switch 106) may forward the message to the enforcement point (e.g., router 112) to further validate whether the network traffic between the third computing device 108c and the first computing device 108a is valid. As another example, however, if a computing device (e.g., first computing device 108a) is part of a given VLAN (e.g., first VLAN 110a, determined based on port-based assignment of SGTs at the network switch 106) and is attempting to communicate with another computing device (e.g., second computing device 108b) that is part of the same VLAN (e.g., first VLAN 110a, determined based on port-based assignment of SGTs at the network switch 106), then the system (e.g., network switch 106) may prevent, or otherwise prohibit further processing of the network traffic (e.g., delete, reject, throw out, stop, etc.) between the two or more devices.

By doing so, the system may reduce the amount of network traffic experienced within the segmented network (e.g., LAN 102) as initially invalid network traffic may be eliminated—thereby further improving cybersecurity within the network. Additionally, by forwarding initially valid network traffic to the enforcement point, the system may further improve cyber security within the network as the enforcement point adds a second layer of cybersecurity by verifying whether the initially valid network traffic is indeed valid. Lastly, by implementing the enforcement point at the network router 112, not only may the WAN associated with WAN center 104 be protected from malicious software/information from being transmitted to the WAN (thereby protecting other LANs from being under a cybersecurity attack), but also may alleviate the central firewalls hosted at the WAN center 104 from being inundated with a large amount of network traffic (which would cause high network traffic latency).

The system may use a set of VLANs to facilitate a segmented network. In disclosed embodiments, a VLAN may be a logically separate computing network that is within a physical computing network. In some embodiments, a set of VLANs may each be logically separate from each other but share software and hardware of the same physical computing network. For example, a first VLAN and a second VLAN may share one or more physical components of a physical computing network (e.g., network switches and routers), however, the first VLAN and second VLAN may operate as its own separate network. In some embodiments, a VLAN may be associated with a logical grouping of one or more devices that share a common characteristic. For example, one VLAN may include a set of devices that are all of the same type (e.g., printer, laptop, etc.). As another example, one VLAN may include a set of devices that are all part of a given business sector (e.g., finance, human resources, information technology, etc.) of an entity (e.g., company, merchant, etc.).

VLANs may segment the network by grouping the devices into different broadcast domains. For example, devices within one VLAN are able to communicate with each other freely as long as the devices communicating with each other are part of the same VLAN. However, devices within different VLANs are unable to communicate with each other without routing or other special permissions. As such, VLANs may restrict broadcasting traffic to only the devices within a given VLAN, thereby reducing the amount of unnecessary traffic and improving network performance by limiting broadcasting storms. Furthermore, VLANS provide additional security benefits by isolating data to the VLAN (e.g., since only devices within a given VLAN can communicate directly with one another). VLANs may be implemented based at least in part on network switches and routers.

For example, the system may use network switches to help implement a VLAN. In disclosed embodiments, a networking device that connects a plurality of computing devices (e.g., laptops, printers, servers, etc.) together within a LAN. A network switch receives data from computing devices, processes data from the computing devices, and forwards data to a destination device (e.g., a receiving device). In some embodiments, network switches may include managed switches, unmanaged switches, Layer 2 switches (e.g., of OSI model), Layer 3 switches (e.g., of OSI model), Power over Ethernet (PoE) switches, or other network switches. In some embodiments, the network switch may be a managed switch. For example, the managed switch may provide VLAN support. In some embodiments, network switches may receive data, such as data packets (e.g., frames) from a computing device at a port of the network switch. The network switch may process the data packet. For example, processing the data packet may include determining a destination address (e.g., a MAC address of an intended receiving device, or other address), inserting a SGT into the data packet, or other data packet processing. The network switch may then forward the data packet to the destination computing device by determining a port to which the destination computing device is assigned or connected to.

In some embodiments, the network switch maintains an address table (e.g., a MAC address table) that maps MAC addresses of computing devices connected to the switch to the specific ports of the network switch that those computing devices are connected to. If a MAC address is not part of the table, the network switch broadcasts the data packet to all ports that are part of the network switch to learn the MAC address of a new computing device (e.g., by receiving a response from the new computing device). By doing so, the network switch is able to forward data packets to the computing devices that are intended to receive the data packets as opposed to generally broadcasting the data packet to each device that is connected to the network switch. Such forwarding is effectuated by determining the destination address in the data packet, determining (e.g., based on the MAC address table) which port the destination computing device is connected to, and then forwarding the data packet to the destination computing device via the port that the destination device is connected to. Where the network switch is a managed network switch with VLAN support, the network switch may be configured to forward data packets to devices that are part of the same VLAN. The network switch may be configured using a configuration profile (e.g., an instruction set, or tagged MAC address table with VLAN identifiers mapped to respective ports) to ensure that data packets are forwarded to devices (or alternatively, ports) that are part of a respective VLAN.

The system may additionally use a router to enable cross VLAN communication where appropriate. In disclosed embodiments, a router may be a networking device that includes home routers, enterprise routers, core routers, edge routers, wireless routers, or other routers. A router may connect multiple computing networks together, direct data packets between the computing networks, determine communication paths for the data packets to travel on across the computing networks, connect LANs to WANs, or perform other functions. In some embodiments, a router may act as a middleman for connecting two or more VLANs together. For example, to facilitate communication between two or more VLANs, a router may be used to forward data packets from one computing device of a first VLAN to a second computing device of a second VLAN. Routers may route data packets between different networks (e.g., VLANs, LANs, WANs, etc.) by determining a routing path using routing tables and other algorithms. The router may process received data packets. For example, the router may determine a destination Internet Protocol (IP) address of each data packet it receives and use the destination IP address to determine which network to send the data packet. Routers may also perform Network Address Translation (NAT), where multiple computing devices that are part of a network share a single public IP address when accessing a computing network/Internet. NAT translates the IP addresses of devices part of the computing network into a public IP address used by the router to communicate with other networks.

To facilitate secure communications between computing devices of VLANs, the router may be an enforcement point (or host an enforcement point). For example, an enforcement point may be a policy enforcement point, such as a firewall. The policy enforcement point may include one or more network traffic policies indicating valid and invalid network traffic flows between computing devices. For example, the router may include a firewall (e.g., a managing firewall) that manages network traffic between computing devices of computing networks (e.g., VLANs) by verifying, based on the network traffic policies, whether the network traffic between a first computing device of a given computing network and a second computing device of another computing network is valid or invalid.

In some embodiments, the network traffic policies may indicate a direction of the network traffic. For example, where a first computing device transmits data, and a second computing device receives the data, a network traffic policy may indicate that network traffic is valid or invalid based on the direction of the network traffic (e.g., which computing device is transmitting the data packet and which device is to receive the data packet). In some embodiments, the network traffic policies may be based on SGTs of respective computing devices. For example, where a first computing device is associated with a first SGT and a second computing device is associated with a second SGT, the network traffic policy may indicate that the network traffic is valid or invalid based on the respective SGTs involved (e.g., based on one or more inserted SGTs within the data packet, based on port assignments of SGTs of a network switch, etc.). In some embodiments, the network traffic policies may be based on known device profiles. For example, where computing devices are profiled when onboarded to computing networks that the router is associated with, the network traffic policy may indicate whether the network traffic is valid or invalid based on respective computing devices being profiled or not. In some embodiments, the network traffic policies may be based on gateway addresses associated with the computing devices. For example, a gateway address may be an IP address of a router. Where computing devices are attempting to communicate with one another and each are associated with a different gateway address of a router to effectuate the communication, the network traffic polices may indicate whether the network traffic between the respective computing devices is valid or invalid based on the gateway addresses associated with the respective computing devices. Additionally or alternatively, the network traffic policies may indicate whether the network traffic between respective computing devices is valid or invalid based on MAC addresses corresponding to the respective computing devices. In some embodiments, the network traffic policies may be based on time. For example, the network traffic policies may indicate valid or invalid network traffic between two or more computing devices based on a time at which the two devices are attempting to communicate. In some embodiments the network traffic policies may be based on other characteristics, such as indicating that specific network traffic between two or more computing devices is valid or invalid based on the specific devices, a specific user, a specific category or grouping to which the computing devices belong to, the type of data (e.g., transactional data, sensitive data, Personally Identifying Information (PII), software updates, malware, information indicative of a cybersecurity attack, etc.) being communicated, or other characteristics.

The system may use the network switch and enforcement points together to reduce data storage requirements associated with facilitating secure, scalable, segmented networking communications. For instance, while the enforcement points may act as a second layer of cybersecurity by determining whether network traffic flows between two or more computing devices are valid/invalid, the network switch may be uniquely configured to reduce data storage requirements traditionally associated with providing a first layer of cybersecurity. As opposed to existing systems that leverage large, cumbersome, ACLs to define valid and invalid network traffic within a VLAN, systems and methods described herein provide a unique configuration of the network switch, where, in some embodiments, when combined with the enforcement points facilitate secure, scalable, segmented computing network communications. In some embodiments, the system may use SGTs at the network switch level that adhere to a single rule: network traffic between computing devices associated with the same SGT is invalid, to provide the first layer of cybersecurity. By doing so, the system uniquely balances the cybersecurity benefits of PVLAN technology with the scalability benefits of VLAN technology, while adding a second layer of cybersecurity via the enforcement points.

As such, the system may use Security Group Tags (SGTs). In disclosed embodiments, an SGT may be a tag that indicates a security attribute of a computing device, a user of a computing device, or other information. For example, an SGT may indicate a VLAN that a computing device is associated with, part of, or included in. As another example, an SGT may be user-based, where users are associated with an SGT when they log in to or operate a computing device. SGTs provide a mechanism to enhance access control and segment a network. In some embodiments, SGTs may be unique with respect to other SGTs. For example, an SGT may not have the same identifier as another SGT. In some embodiments, one or more computing devices may be associated with an SGT. For example, a first computing device may be associated with a first SGT, and a second computing device may be associated with the first SGT. In some embodiments, one or more computing devices may be associated with different SGTs. For example, a first computing device may be associated with a first SGT and a second computing device may be associated with a second SGT. Computing devices that are associated with the same SGT may share a common characteristic. For example, when segmenting a network based on a device type (e.g., printer, laptop, telephone), a first computing device and a second computing device that are each printers may be associated with a first SGT denoting that the first computing device and the second computing devices are printers. SGTs enable a logical grouping of computing devices. In some embodiments, SGTs may be associated with a VLAN. For example, in disclosed embodiments, an SGT may represent a VLAN identifier. For example, a computing device may be part of a first VLAN, and as such, the computing device may be tagged with an SGT that indicates that the computing device is part of the first VLAN.

Network switches may insert SGTs into data packets to which the network switch receives. For example, in disclosed embodiments, SGTs may be associated with, mapped to, or assigned to ports of a network switch. The network switch may not only maintain a MAC address list of computing devices connected to ports of the network switch, but also have a configuration profile that indicates (i) ports associated with given VLANs and (ii) SGTs associated with those VLANs. As such, when a network switch receives a message (e.g., a data packet) from a first computing device connected to a first port of the network switch, the network switch can insert a corresponding SGT into the data packet by referring to the configuration profile indicating which SGT to insert into the data packet, based on the VLAN that the port is associated with. By inserting the SGT into the data packet, further processing of the data packet (e.g., by the router or other components of a network) may be aware of which VLAN the message was transmitted from. By doing so, the system may improve cybersecurity within the network by knowing where information is being transmitted from and is being transmitted to. In some embodiments, the inserted SGT may be a receiving SGT and a transmitting SGT. For example, while the network switch may receive a data packet from a first computing device, the data packet may be intended on being forwarded to a second computing device. Not only may the network switch insert a SGT corresponding to the device that has transmitted the data packet, but may also insert a second SGT (e.g., based on a port configuration of the network switch) to indicate the SGT (or VLAN) associated with the receiving device (e.g., a second computing device intended to receive the data packet)—thereby further improving cybersecurity of the network when the data packet is additionally processed for valid or invalid network traffic (e.g., at the enforcement point or other component of the computing network).

The system may be used to facilitate communication between primary devices of a computing network by using a secondary device of the computing network. In some embodiments, a primary device may be computing devices that generate, modify, transmit, or receive information. For example, primary devices may include laptop computers, printers, telephones, personal digital assistants (PDAs), wearable devices (e.g., smart watches, smart rings, headphones, headsets, virtual reality headsets, earpieces), servers, databases, mice, speakers, monitors, displays, or other computing devices. In some embodiments, a secondary device may be a networking device that is intended to facilitate, support, or enable communications over one or more computing networks. For example, secondary devices may include network switches, routers, firewalls, Access Points (APs), modems, Network Attached Storage (NAS) devices, hubs, bridges, gateways, load balancers, or other networking devices.

FIG. 2 shows an illustrative diagram for communicating a message between primary devices of a computing network using SGT-based and enforcement point-based communication control, in accordance with one or more embodiments. For example, FIG. 2 shows diagram 200, including primary devices 202 (e.g., first primary device 202a and second primary device 202b), secondary devices 204 (e.g., first secondary device 204a and second secondary device 204b), a message 206, enforcement point 208, and communication links 210 (or communication links 210a-210d). Message 206 may include one or more message portions 206a-206o. As will be described, message 206 may be processed by (or one or more message portions 206a-206o may be processed by) first secondary device 204a. Enforcement point 208 may be part of, implemented on, or associated with second secondary device 204b.

In accordance with disclosed embodiments, FIG. 2 shows first primary device 202a attempting to communicate with a second primary device 202b. To reduce data storage requirements associated with facilitating secure, scalable, segmented networking communications, the first secondary device 204a and the second secondary device 204b may control communication between the first primary device 202a and the second primary device 202b. For example, the first secondary device 204a may control communication between the first primary device 202a and the second primary device 202b using SGT-based communication control, and the second secondary device 204b may control communication between the first primary device 202a and the second primary device 202b using enforcement point-based communication control. The SGT-based communication control may control or otherwise determine, at the first secondary device 204a, whether network traffic between the first primary device 202a and the second primary device 202b is initially valid based on SGTs associated with the first primary device 202a and the second primary device 202b using port mapping/assignments of VLANS and the respective devices. For instance, the first secondary device 204a may be a network switch. The enforcement point-based communication control may control or otherwise determine, at the second secondary device 204b, whether network traffic between the first primary device 202a and the second primary device 202b is subsequently valid based on one or more network traffic policies via enforcement point 208. For instance, the second secondary device 204b may be a router, and enforcement point 208 may be a firewall that is part of, hosted on, or implemented on the router (e.g., secondary device 204b).

In some embodiments, first primary device 202a may intend to transmit a message to second primary device 202b. To do so, primary device 202a may transmit the message 206 via first communication link 210a. When message 206 is transmitted to be received at second primary device 202b, the message may be passed to first secondary device 204a. First secondary device 204a may be a network switch that is configured with a configuration profile to provide SGT-based communication control. For instance, the network switch may be configured based on a configuration profile that indicates an instruction to prevent message 206 from being forwarded via second communication link 210b if the first primary device 202a is associated with (e.g., part of) the same VLAN as the second primary device 202b. By doing so, the system need not store or refer to a large Access Control matrix defining valid and invalid network traffic between devices, but rather permit or prohibit invalid or valid network traffic between devices in real time, thereby further reducing network traffic over or between one or more VLANs. To do so, when message 206 is received at the network switch (e.g., first secondary device 204a), the network switch may determine which port the message was received at. For example, each port that is part of the network switch may be associated with (i) a device connected to the respective port and (ii) a VLAN identifier that is associated with the respective port. As such, when message 206 is received at the network switch, the network switch is able to determine what VLAN the first primary device 202a is associated with (e.g., by referring to the configuration profile and/or MAC address table as described above).

The network switch may then insert an SGT into a portion of the message 206. For example, message 206 may include message portions 206a-206o. Message 206 may adhere to the 802.1AE communication protocol or other communication protocols to implement SGT, in accordance with one or more embodiments. First message portion 206a may indicate a DMAC. For example, the DMAC may be a destination MAC address of an intended receiving device (e.g., second primary device 202b). Second message portion 206b may indicate an SMAC. For example, the SMAC may be a source MAC address of the transmitting device (e.g., first primary device 202a). Third message portion 206c may indicate a header. For example, the header may be an 802.1AE header. Fourth message portion 206 d may indicate a Q. For example, the Q may indicate a VLAN identifier indicating a VLAN that the port is associated with. Fifth message portion 206e may include a Command. For example, the Command portion may indicate a set of other message portions (e.g., message portions 206j-206o). Sixth message portion 206f may indicate an ETYPE. For example, the ETYPE may refer to the EtherType field indicating a protocol encapsulated in the payload of the frame (e.g., message 206). Seventh message portion may include a Payload. For example, the payload may indicate the data to be transmitted to a receiving device (e.g., second primary device 202b). Eighth message portion 206h may indicate an ICV. For example, the ICV may indicate the integrity check value to determine whether the frame (e.g., message 206) has been tampered with during communication. Ninth message portion 206i may indicate a CRC. For example, the CRC may indicate a cyclic redundancy check value. Tenth message portion 206j may indicate an EtherType. For example, the EtherType may be similar to that of the ETYPE, however, being related to the payload of the CMD message portion. Eleventh message portion 206k may indicate a version. For example, the version may indicate the secure device identity's credentials or certificates to uniquely identify a computing device. Twelfth message portion 206l may indicate a length. For example, the length may be a length of the SGT information being carried in a MACsec frame. Thirteenth message portion 206m may indicate an SGT Opt Type. The SGT Opt Type may refer to the type of SGT. Fourteenth message portion 206n may indicate an SGT value. For example, the SGT value may be an identifier indicating the SGT that is part of or to be inserted into message 206. Fifteenth message portion 206o may indicate another value.

Continuing with the example above, when message 206 is received at the network switch, the network switch may determine an SGT to insert into the fourteenth message portion 206n. For example, the network switch may determine, based on the configuration profile, which VLAN first primary device 202a is part of. Upon determining which VLAN first primary device 202a is part of, the network switch may select a corresponding SGT that is associated with the VLAN to be inserted into fourteenth message portion 206n. In one use case, where first primary device 202a is part of second VLAN 110b (FIG. 1), network switch 106 (e.g., first secondary device 204a) may receive a message (e.g., message 206) from the first primary device 202a. The network switch may then determine that the first primary device 202a is part of second VLAN 110b and may insert an SGT corresponding to the second VLAN 110b into the fourteenth message portion 206n. For example, the network switch may access the configuration profile to determine which port the message has been received at, select an SGT (e.g., from a table) that corresponds to the port that received the message (e.g., indicating which VLAN the port is configured to), and then insert the SGT into the fourteenth message portion 206n. Upon inserting the appropriate SGT into message 206, the first secondary device 204a may determine whether to forward the now updated message 206 to second secondary device 204b, or to prohibit further forwarding or processing of message 206.

For instance, in a first case where first primary device 202a intends on transmitting message 206 to second primary device 202b, where first primary device 202a is part of second VLAN 110b (FIG. 1) and second primary device 202b is also part of second VLAN 110b, first secondary device 204a may prohibit further processing, forwarding, or transmission of message 206. For example, when the network switch (e.g., first secondary device 204a) inserts the SGT into message 206, the network switch may determine, based on first message portion 206a which device the message 206 is to be transmitted to. For instance, the network switch may access a MAC address table based on the DMAC of the first message portion 206a to determine which device to forward the message to. The network switch may then determine (e.g., based on the configuration profile, a mapping of ports to MACs, etc.) which port to forward the message 206 to, thereby in effect, determining which device to forward the message to.

In this example, because the first primary device 202a and the second primary device 202b are part of the same VLAN, the network switch may prevent message 206 from being forwarded (e.g., transmitted) to the second primary device 202b via second communication link 210b. For instance, the network switch may determine that DMAC of message 206 is associated with a port of the second VLAN 110b, which is further associated with an SGT that is the same as that of the first primary device 202a. In other words, because the ports of the network switches are configured to specific VLANS, and the VLANs are associated with SGT's that are inserted into the messages, the network switch may determine, based on the port assignments/mappings of VLANS or SGTs assigned to those ports, whether to forward the message to (i) the second primary device 202b or (ii) the second secondary device 204b. As in this case, since the network switch has determined that the SGT or VLANs associated with the first primary device 202a and the second primary device 202b are of the same SGT (or VLAN), then the network switch may prevent forwarding of message 206 to the second primary device 202b, thereby improving intra-VLAN cybersecurity. Additionally, by doing so, such implementation at the network switch-level provides the cybersecurity advantages of PVLAN technology while maintaining the scalability advantages of VLAN technology.

In a second case, where first primary device 202a intends on transmitting message 206 to second primary device 202b, where first primary device 202a is part of second VLAN 110b (FIG. 1) and second primary device 202b is part of first VLAN 110a, first secondary device 204a may forwarding message 206 to second secondary device 204b via third communication link 210c. For example, when the network switch (e.g., first secondary device 204a) inserts the SGT into message 206, the network switch may determine, based on first message portion 206a which device the message 206 is to be transmitted to. For instance, the network switch may access a MAC address table based on the DMAC of the first message portion 206a to determine which device to forward the message to. The network switch may then determine (e.g., based on the configuration profile, a mapping of ports to MACs, etc.) which port to forward the message 206 to, thereby in effect, determining which device to forward the message to.

In this example, because the first primary device 202a and the second primary device 202b are part of different VLANs, the network switch may forward the message 206 to second secondary device 204b via third communication link 210c in lieu of forwarding the message 206 directly to the second primary device 202b via second communication link 210b. For instance, the network switch may determine that DMAC of message 206 is associated with a port of the first VLAN 110a, which is further associated with an SGT that is different than that of the first primary device 202a. In other words, because the ports of the network switches are configured to specific VLANS, and the VLANs are associated with SGT's that are inserted into the messages, the network switch may determine, based on the port assignments/mappings of VLANS or SGTs assigned to those ports, whether to forward the message to (i) the second primary device 202b or (ii) the second secondary device 204b. As in this case, since the network switch has determined that the SGT or VLANs associated with the first primary device 202a and the second primary device 202b are of different SGTs (or VLAN)s, then the network switch forward the message 206 to the second secondary device 204b. For example, as described above, while the network switch may be part of the first VLAN 110a and the second VLAN 110b physically, thereby having a physical connection to be able to theoretically communicate with devices that are part of the different VLANs (e.g., via second communication link 210b), the network switch may be configured logically to prohibit such direct communication. In this way, the system may improve cybersecurity across different VLANs by providing a second verification layer to verify whether the network traffic between the different networks (e.g., VLANs) are in-fact valid or invalid.

To do so, the network switch may forward message 206, via third communication link 210c, to the second secondary device 204b. The second secondary device 204b may be a router that hosts an enforcement point 208. For example, the enforcement point may be a managing firewall that includes one or more network traffic policies as described above. The firewall may then determine, based on (i) message 206 and (ii) the network traffic policies, whether message 206 is to be forwarded to the second primary device 202b via fourth communication link 210d. For example, the firewall (e.g., enforcement point 208) implemented on the router (e.g., second secondary device 204b) may verify, according to the network traffic policies described above, whether the network traffic between the first primary device 202a and the second primary device 202b is valid or invalid.

Where the firewall determines that the network traffic between the primary device 202a and the second primary device 202b is valid, the firewall may indicate that the network traffic is valid, and may permit the router (e.g., second secondary device 204b) to forward the message 206 to a gateway address associated with the second primary device 202b. For example, the gateway address may be the address of the second primary device 202b (e.g., MAC address, IP address, etc.) or may be the address of another router that is associated with the second primary device 202b. By doing so, the system may force VLAN to VLAN communications through an enforcement point to further verify whether the network traffic between the respective primary devices are indeed valid, thereby improving cybersecurity across VLANs.

Where the firewall determines that the network traffic between the primary device 202a and the second primary device 202b is invalid, the firewall may indicate that the network traffic is invalid, and may prevent the router (e.g., second secondary device 204b) to forward (or further process) the message 206 to second primary device 202b. For example, where the network traffic is invalid, the router may ignore, delete, or otherwise stop message 206. By doing so, the system may improve cybersecurity across VLANs by preventing restricted communications between primary devices from occurring. Additionally, the system may further protect maliciously-indicative communications from leaving a respective LAN, and infecting the associated WAN with malicious messages (e.g., code, malware, restricted communications) which may negatively impact the computing network as a whole.

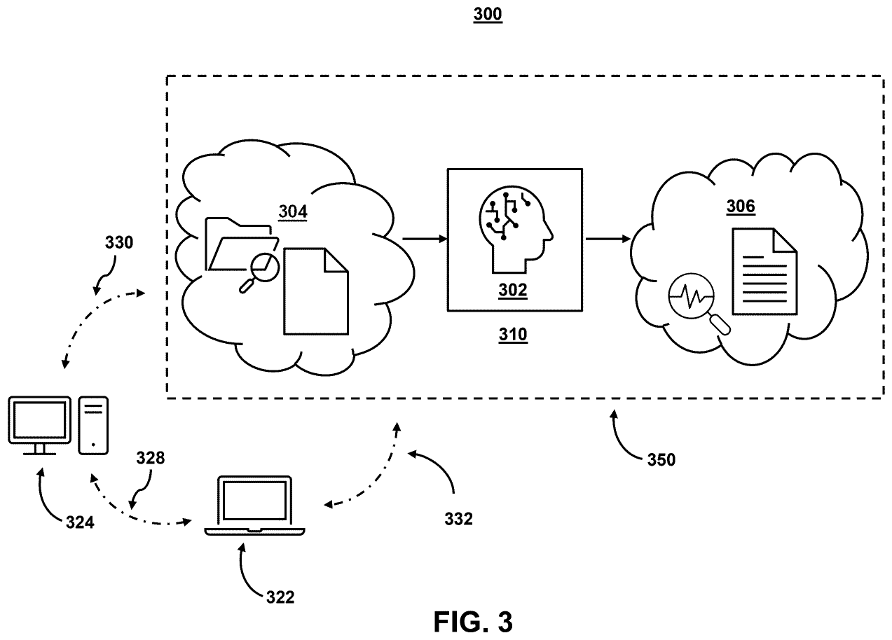

FIG. 3 shows illustrative components for a system used to facilitate secure, scalable, segmented networking communications in accordance with one or more embodiments. For example, FIG. 3 may show illustrative components to reduce data storage requirements associated with facilitating secure, scalable, segmented layer two communications. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. In some embodiments, mobile device 322 may correspond to first primary device 202a (FIG. 2). In some embodiments, user terminal 324 may correspond to second primary device 202b (FIG. 2). FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include one or more components of diagram 200 (FIG. 2) or environment 100 (FIG. 1). For instance, cloud components 310 may include one or more primary devices 202, one or more secondary devices 204, one or more enforcement points 208 (FIG. 2), communication links 210, network switches, routers, or other components implemented (or part of) one or more VLANs, in accordance with one or more embodiments. As another example, cloud component 310 may include one or more LANs 102, WAN centers 104, computing devices 108, network switches 106, routers 112, VLANs 110 communication links 114, or other components (FIG. 1).

Cloud components 310 may access one or more databases. For example, cloud components may access a SGT database storing SGT's, a configuration profile database storing configuration profiles of network switches, MAC address table databases storing MAC address tables for network switches, IP address databases storing gateway addresses or IP addresses of devices, network traffic policy databases storing network traffic policies of a network, device profile databases storing device profiles of devices that are part of a computing network, training data databases for training machine learning models, or other databases storing other information used in accordance with one or more embodiments.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether to forward a message, whether to prevent forwarding of a message, a VLAN associated with a computing device, an SGT associated with a computing device, a communication path to transmit a message on, a set of communication paths to transmit a message on, or other prediction).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether to forward a message, whether to prevent forwarding of a message, a VLAN associated with a computing device, an SGT associated with a computing device, a communication path to transmit a message on, a set of communication paths to transmit a message on, or other classification).

In some embodiments, the model (e.g., model 302) may automatically perform actions based on outputs 306. In some embodiments, the model (e.g., model 302) may not perform any actions. The output of the model (e.g., model 302) may be used to determine whether to forward a message, to prevent forwarding of a message, determine a VLAN associated with a computing device, determine an SGT associated with a computing device, determine a communication path to transmit a message on, determine a set of communication paths to transmit a message on, or other action).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

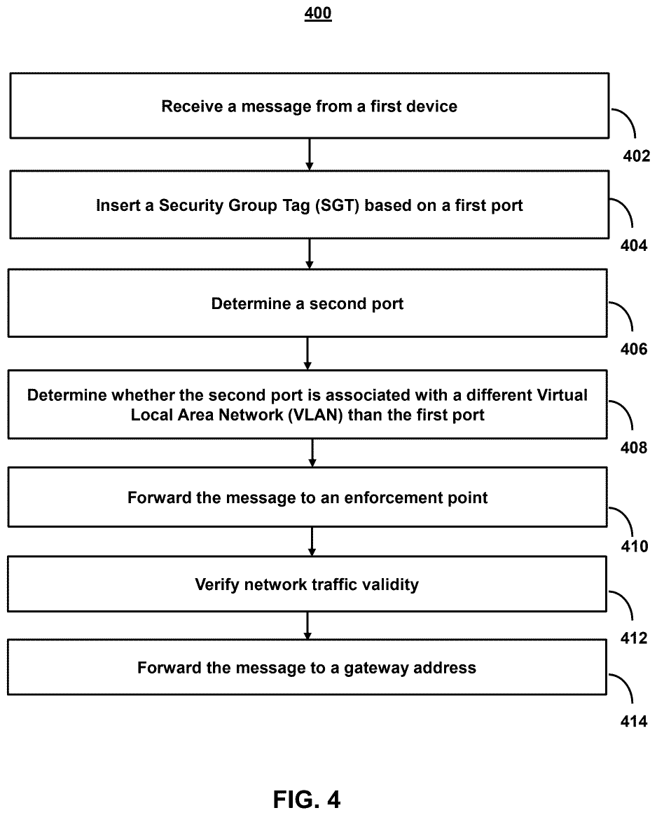

FIG. 4 shows a flowchart of the steps involved in reducing data storage requirements associated with facilitating secure, scalable, segmented network communications, in accordance with one or more embodiments. For example, the system may use process 400 (e.g., as implemented on one or more system components described above) to reduce data storage requirements associated with facilitating secure, scalable, segmented layer two communications.

At step 402, process 400 (e.g., using one or more components described above) may receive a message from a first device. For example, the system may receive a message, from a first device, at a first port mapped to a first VLAN, to communicate with a second device. The message may include a first address associated with the first device and a second address associated with the second device. The message may be a communication request for transmitting information from the first device to the second device.

For example, as discussed with respect to FIG. 2, a network switch may receive a message (e.g., a communication request) from a first device at a first port of the network switch. The first port may be mapped (e.g., associated with) a first VLAN. For example, each port of the network switch may be dynamically configured based on a mapping to a respective VLAN of a segmented computing network. The mapping may be based on a configuration profile associated with the network switch, may be based on a table indicating port assignments to respective VLANs, or tagged MAC address table, or other basis. Each VLAN that is associated with (e.g., connected to) the network switch may include a set of computing devices. For example a first VLAN may be associated with a first set of computing devices and a second VLAN may be associated with a second set of computing devices. The mapping may map ports of a network switch to (i) a VLAN of a set of VLANs and (ii) a computing device of a set of computing devices. Such mapping may be a predetermined mapping (e.g., retrieved from a database) or may be configured by a user. Additionally, as described above, each VLAN may be associated with a SGT. For instance, the first VLAN may be associated with a first SGT, and the second VLAN may be associated with a second SGT. In accordance with some embodiments, the first SGT may be the same as, or different from the second SGT.

In some embodiments, the first and second addresses of the message may be MAC addresses. For example, where the message is an initial communication request to communicate with a second device, the first device may not have been assigned an IP address yet. As such, the system may use MAC addresses to locate where a device may be located within the network until being assigned an IP address. As another example, where the message includes information to be communicated with another device, the first address may indicate a source address (e.g., SMAC) associated with the first device and the second address may be a destination address (e.g., DMAC) associated with the second device. For example, as discussed with respect to FIG. 2, the message may include the SMAC and DMAC to enable the network switch (or other components of the system) to know where a message originated from and where a message is destined to be transmitted to. As yet another example, the system may identify a first MAC address of the first device and then determine the first address of the first device based on the first MAC address (e.g., the first address associated with the first device being the first MAC address). Similarly, the system may identify a second MAC address of the second device and then determine the second address of the second device based on the second MAC address (e.g., the second address associated with the second device being the second MAC address).

In some embodiments, the first address and the second address may be IP addresses. For example, where the first device and the second device are known devices and have been onboarded onto the network, the system may assign them permanent IP addresses to enable the system to accurately forward messages to the respective devices. For example, as opposed to assigning devices static IP addresses, the system may use a DHCP Reservation process (e.g., via a DHCP Server) to assign a permanent IP address to devices. For example, the system may receive a first DHCP Reserved IP address from the DHCP server for the first device and then determine the first address based on the first DHCP Reserved IP address (e.g., the first address associated with the first device being the first DHCP Reserved IP Address). As another example, the system may receive a second DHCP Reserved IP address from the DHCP server for the second device and then determine the second address based on the second DHCP Reserved IP address (e.g., the second address associated with the second device being the second DHCP Reserved IP Address). In this way, DHCP Reserved IP addresses enable the system to use a given IP address range for a given VLAN to provide flexibility in the future. For example, when a threshold amount of devices for the VLAN segment is exceeded, the system may update the IP address range to a larger range to accommodate additional devices without requiring each device within the given VLAN segment to be reassigned an IP address.

In some embodiments, the system may onboard one or more devices onto a given VLAN prior to enabling the device to freely communicate within the computing network. For example, the system may receive an access-request message from a third device, at a third port mapped to a third VLAN, where the access-request message comprises a third address associated with the third device. For example, the system may receive at a network switch, an access-request message from a primary device to be onboarded onto the system. The access-request message may include one or more certificates or Media Access Control (MAC) addresses of the primary device. The system (e.g., the network switch) may forward the access-request message to an enforcement point (e.g., a managing firewall) configured to generate a third device profile for the device to be onboarded. For example, the third device profile may include (i) a third SGT corresponding to an SGT assigned to the third port, (ii) a VLAN identifier corresponding to the third VLAN, (iii) a gateway address corresponding to the third VLAN, and (iv) a MAC address of the third device.

The system may store, by the managing firewall, the third device profile in a database associated with the managing firewall. For example, the managing firewall may be communicatively coupled to a device profile database configured to store device profiles of devices. In some embodiments, the device profile database may be implemented (e.g., hosted) on the same component (e.g., second secondary device 204b (FIG. 2), the router 112 (FIG. 1), etc.) as the managing firewall. Alternatively, the device profile database may be implemented on a different component from the managing firewall.

The storing of the third device profile may be an indication that the third device is onboarded to the system (or the respective VLAN). For example, the system may onboard devices to a given VLAN prior to permitting free access to the resources available within the given VLAN. By doing so, the system may trust devices that are part of a given VLAN—thereby enhancing cybersecurity of computing networks. In some embodiments, the third device may be the first device (as discussed above), and the third VLAN may be the first VLAN. By doing so, prior to receiving messages to be communicated to other primary devices within the computing network, the system may onboard and trust respective devices operating within the computing network.

At step 404, process 400 (e.g., using one or more components described above) may insert a SGT based on a first port. For example, the system may insert, based on receiving the message at the first port mapped to the first LAN, a SGT that is assigned to the first port into the message. For example, the system may insert a first SGT into the communication request based on receiving the communication request at the first dynamically configured port that is mapped to a first VLAN. For example, as a network switch may receive messages (e.g., communication requests) from computing devices at given ports of the network switch, such ports may be configured to process the messages. Since the ports are each configured to receive such information (e.g., messages) and are mapped to respective computing devices and VLANs, the network switch may access the configuration profile (e.g., indicating mappings of ports to VLANs and the SGT associated with the respective VLAN/port) to retrieve the SGT corresponding to the port. The network switch may then insert the SGT corresponding to the port at which the message was received at into a portion of the message. By doing so, the system may tag the message with information indicating which VLAN the computing device transmitting the message from is associated with, thereby improving cybersecurity as network traffic may be validated by one or more components (e.g., enforcement points) where the message leaves a respective VLAN.

In some embodiments, the system may insert the SGT that is assigned to the first port into the message based on a configuration profile that is associated with a set of ports. For example, a network switch (e.g., a secondary device that is part of one or more VLANs) may be associated with a predetermined configuration profile that assigns which ports of the set of ports are mapped to respective VLANs. For example, a first port of the network switch may be mapped to a first VLAN, a second port of the network switch may be mapped to the first VLAN, a third port of the network switch may be mapped to a second VLAN, and so on. The configuration profile may identify a port (e.g., based on a port identifier, such as a number, string, decimal, hexadecimal, alphanumeric, or other value) and indicate which VLAN to which the port is assigned to, mapped to, or otherwise associated with. For example, the configuration profile may map ports to VLANs based on port identifiers and VLAN identifiers (e.g., a number, string, decimal, hexadecimal, alphanumeric, or other value).

The system may determine an SGT that is assigned to the first port based on a configuration profile associated with a set of ports. For example, the system (or the network switch) may access the configuration profile to determine what SGT has been assigned to the first port, thereby indicating which VLAN the port is associated with (e.g., based on a match). The system may then extract the determined SGT into the message at the SGT portion of the message. For example, as the message may include one or more message portions (e.g., message portions 206a-206o (FIG. 2)) and the system may identify from the one or more message portions, which message portion corresponds to accepting an SGT (e.g., fourteenth message portion 206n (FIG. 2)). The system may then insert the determined SGT into the message at the corresponding SGT portion. In this way, when messages are transmitted within the VLAN, the switch may insert the SGT into such messages. By doing so, the system may verify whether network traffic between two or more devices is permitted, thereby enhancing cybersecurity of the computing network.

At step 406, process 400 (e.g., using one or more components described above) may determine a second port. For example, the system may determine, based on the second address of the message, a second port to forward the message to be received by the second device. For instance, the second address may be the destination address (e.g., DMAC) of a second computing device to which the message is to be received at. The network switch may determine which port to forward the message to based on (i) the second address and (ii) the configuration profile of the network switch. The second port may be associated with a second VLAN. For example, the second VLAN may be the VLAN to which the second device is part of. By determining the second port, the system is able to determine (i) which VLAN the second device to receive the message is part of and (ii) the SGT associated with the second port. By doing so, as will be described later, the system may improve intra-VLAN cybersecurity and inter-VLAN cybersecurity by providing a first layer of verification as to whether the network traffic between the first device and second device is valid or invalid.

At step 408, process 400 (e.g., using one or more components described above) may determine whether the second port is associated with a different VLAN than the first port. For example, the system may determine, based on an assigned SGT to the second port, whether the second VLAN is different from the first VLAN. Additionally or alternatively, the system may determine, based on the configuration profile, whether the second port is associated with a VLAN that is different from that of the first port. While on its surface, determining whether ports are associated with different VLANs based on SGTs or based on the configuration profile appear redundant, each have their own use.

For example, in larger VLAN networks where multiple network switches are involved, a message may be processed by multiple network switches before reaching the destination device. Solely using a configuration profile to determine which ports are mapped to a given VLAN may not adequately inform the system as to whether the message should be forwarded to an enforcement point or should be prevented from being forwarded. In the case where multiple network switches process the message, due to the potential that such network switches may involve a different set of VLANs with respect to another network switch, a given network switch may not have a configuration profile that identifies a VLAN assigned to a port to which the message is to be forwarded to. While referring to the configuration profile to determine which VLAN the second port is assigned to when one network switch is involved, the system may also use SGT-based VLAN identification. As such, in some embodiments, the system may determine whether a first network switch is physically connected to both (i) the device transmitting the message and (ii) the device to receive the message. If the system determines that the network switch is physically connected to both (i) the device transmitting the message and (ii) the device to receive the message, then the system may use configuration-profile-based VLAN determination. If the system determines that the network switch is not physically connected to both (i) the device transmitting the message and (ii) the device to receive the message, then the system may use SGT-based VLAN determination.

For instance, in some embodiments, the system may determine an SGT that is part of the first message (e.g., indicating which device has transmitted the message) and also determine which SGT is assigned to the second port. For example, the network switch may determine which SGT is part of the message that the network switch has received at the first port, and the network switch may also determine which SGT is assigned to the second port based on the configuration profile associated with the network switch. The network switch may then determine whether the SGTs of (i) the message and (ii) the SGT assigned to the second port are different from each other. For instance, because each VLAN is associated with a unique SGT, when the SGT of the message is the same as the SGT as assigned to the second port are the same SGT (e.g., based on a match), the system may determine that the first VLAN is the same as the second VLAN. Additionally, if the SGT of the message is different from that of the SGT as assigned to the second port, the system may determine that the first VLAN is different from that of the second VLAN.

As such, if the first VLAN is the same as the second VLAN, the system may prevent forwarding of the message (e.g., communication request), via the second port (e.g., of the network switch), in lieu of forwarding the communication request to an enforcement point. Additionally or alternatively, if the first VLAN is different from that of the second VLAN, the system may forward the message to the enforcement point. The enforcement point may be a router that includes (or is associated with) a managing firewall that provides a second layer of cyber security to verify whether network traffic between the first and second device is valid or invalid (e.g., whether the first device is allowed to communicate with the second device). By using network-switch level network traffic control, the system may not only reduce data storage requirements associated with ACLs and offer a first layer of cybersecurity protection, but also reduce the amount of unnecessary network traffic experienced within or across VLANs when determined to be initially invalid network traffic.

In some embodiments, the first port and the second port are part of a network switch that is part of both (i) the first VLAN and (ii) the second VLAN. For example, due to the high cost associated with network switches, the system may be implemented such that the network switch is part of multiple VLANs. For instance, while the network switch may be part of the multiple VLANS, due to ports being configured on the network switch, the system may separate direct communication from one VLAN to another VLAN but use a single component (e.g., the network switch)—thereby reducing the high costs associated with using stand-alone switches per VLAN.

In some embodiments, the network switch may be configured to automatically deny (or invalidate) network traffic involving two devices that are associated with the same SGT. For instance, as described above, due to the very nature of VLANs enabling communication between devices of the same VLAN without any security, other than preventing devices that are not part of the same VLAN from communicating with one another, a cybersecurity vulnerability exists as it may be uncommon for certain devices of the same category to communicate with one another. For example, it may be indicative of a cybersecurity attack when a printer communicates with another printer (e.g., due to there being no normal reason as to why two printers must communicate with one another).

While PVLAN technology may fill this gap by preventing devices (e.g., primary devices) within a PVLAN to communicate with one another, PVLAN technology is outdated and has limited support for devices and the communication protocols they use. To overcome this, the system implements a unique configuration to the VLAN by preventing devices that are associated within the same VLAN (e.g., thereby having the same SGT) from communicating with each other at the switch level (e.g., secondary device level). For instance, each switch that is part of a given VLAN may be configured to prevent forwarding of messages to devices that are associated with the same SGT. Alternatively, each switch that is part of a given VLAN may be configured to prevent forwarding of messages to ports that are assigned the same SGT (e.g., since ports are assigned SGT). In this way, the system balances the pitfalls of PVLAN technology, while decreasing the amount of computer memory required to store a vast array of Access Control Lists, and further improves cybersecurity among the computing network.

At step 410, process 400 (e.g., using one or more components described above) may forward the message to an enforcement point. For example, in response to determining, based on the assigned SGT to the second port, that the second VLAN is different from the first VLAN (e.g., to which the transmitting device that transmitted the message is part of), the system may forward the message to the enforcement point to further verify whether the network traffic between the first device and the second device are valid in lieu of preventing forwarding of the message. For example, as described above, the enforcement point may be a router that includes (or is associated with) a managing firewall that provides a second layer of cyber security to verify whether network traffic between the first and second device is valid or invalid (e.g., whether the first device is allowed to communicate with the second device). In some embodiments, the managing firewall may also include device profiles of a set of devices (e.g., the first device and the second device) to further validate the network traffic between the first and second device. By doing so, the system may provide a second layer of cyber security that ensures that network traffic across VLANs are valid or invalid.

At step 412, process 400 (e.g., using one or more components described above) may verify network traffic validity. For example, the system may verify, at the managing firewall, based on one or more network traffic policies, that network traffic between the first device and the second device is valid. For example, the managing firewall may verify, based on (i) the one or more network traffic policies and (ii) a first device profile corresponding to the first device and a second device profile corresponding to the second device, whether the network traffic communication between the first device and the second device is valid. By doing so, the system further improves cybersecurity across VLANs while reducing network traffic at centralized firewalls (e.g., at the WAN center).

In some embodiments, the system may determine whether network traffic between the first device and the second device is valid based on whether the first and second devices are known devices. For example, the system may obtain, at the managing firewall, a first network traffic policy of the one or more network traffic policies indicating that network traffic between known devices are valid. The system may then extract, at the managing firewall, the first address associated with the first device and the second address associated with the second device from the message. For example, the system may extract an IP address or a MAC address corresponding to each of the devices from the message.

The system may then determine, at the managing firewall, whether a first device profile exists for the first device, and a second device profile exists for the second device. For example, a database storing device profiles may be accessed to determine whether a corresponding device profile exists for (i) the first device based on the first address of the message, and (ii) the second device based on the second address of the message. While determining that the devices are part of different VLANs (e.g., based on which ports are associated with a given VLAN/SGT, and which ports receive and send information between the two devices) improves cybersecurity within a given VLAN by preventing primary devices of a same VLAN from communicating with one another improve cybersecurity within a given VLAN segment, the system may further check whether the devices attempting to communicate have officially been onboarded by the system, and rather, have not gained unauthorized access to a given VLAN segment. As such, the system may determine whether a device profile exists for each of the devices attempting to communicate (or otherwise exchange information with each other). In some embodiments, the existence of such device profiles may indicate whether the devices are “known” by the system, thereby being deemed “safe.” By doing so, the system may further improve cybersecurity of a computing network by verifying whether device profiles exist for the devices attempting to communicate with each other.

In some embodiments, the system may determine whether network traffic between the first device and the second device is valid based on SGT-based network traffic policies. For example, the system may obtain, at the managing firewall, a first network traffic policy of the one or more network traffic policies indicating SGT-based valid network traffic. For example, the one or more network traffic policies may be based on a status of a device (e.g., whether the device is known, whether the device is online, whether the device is able to receive data, whether the device is able to send data, whether the device is public/private, etc.), SGT-based (e.g., indicating valid network traffic between devices that are associated with one or more VLANS), or other information.

The system may then obtain, at the managing firewall, by accessing a database based on the extracted first address and the second address, a first device profile corresponding to the first device and a second device profile corresponding to the second device. The database may store device profiles of devices that are part of a computing network. For example, each device profile may include (i) an SGT, (ii) a VLAN identifier, (iii) a gateway address associated with the VLAN identifier, and (iv) a Media Access Control (MAC) address, (v) a known status, (vi) an IP address, (vii), a device serial number, (viii) a public/private connection indication (e.g., to indicate whether the device is a private device only receiving/sending communication from approved devices, or whether the device is a public device that is able to receive communications from other unapproved or non-specially-permissioned devices), or (ix) other information that corresponds to a particular device.

The system may extract a first SGT corresponding to the first device from the first device profile, and a second SGT corresponding to the second device from the second device profile. For example, SGT's may correspond to devices given the segmented nature of the network (e.g., LAN 102 (FIG. 1)). For instance, because the network is segmented into different VLANs, where each VLAN hosts primary devices of the same type, a SGT may be associated with each primary device. As SGTs are inserted into messages by one or more network switches, when a message is received by a network switch at a port that is configured to receive communications from a given VLAN, the device that is communicatively coupled (e.g., connected to) that port will automatically have a SGT corresponding to the given VLAN into any information (e.g., messages, requests, etc.) that the network switch receives at that port.

When the device is onboarded onto the network, the system generates a device profile for the device to act as a source of “device trust.” As such, the system may leverage the device profiles to verify whether traffic flows between particular devices that are associated with particular SGTs are valid (e.g., allowed). While relying on the SGT's as inserted by the switch may prove that a device is communicating from a given VLAN, leveraging the device profiles provide enhanced cybersecurity as these are generated during onboarding of the device, thereby providing an indication as to whether the devices are “known” to the system.

The system may then determine whether network traffic between a device being associated with the first SGT and a device being associated with the second SGT is valid based on the first network traffic policy. For example, the first network traffic policy may be a list, matrix, or other data structure defining valid network traffic between respective SGTs. By having the policy as a data structure of defining only valid network traffic, the system may reduce the amount of computer memory required to define these valid traffic flows as all other SGT-based network traffic can be considered invalid traffic flows (e.g., due to not having an explicitly defined valid network traffic status between SGTs).

As another example, the policy may define invalid network traffic between respective SGTs. For instance, where the amount of invalid network traffic SGT combinations may be below a threshold value (e.g., a small number of invalid network traffic communications between respective SGTs), then the policy may indicate only those invalid network traffic communications to (i) decrease the amount of computer memory required to store such associations and (ii) verify SGT-based network traffic communications faster via reduced search time (e.g., searching for a given combination of SGTs).

As yet another example, the policy may define invalid network traffic based on a given device being associated with an SGT being prohibited from receiving information from another SGT. For example, one device may be allowed to (e.g., valid network traffic) if it receives data from a device associated with a given SGT. However, that same device may be prohibited (e.g., invalid network traffic) if it sends data to the device of the given SGT. In this way, the system may enforce one-way communication on certain devices belonging to certain VLANs, thereby improving cyber-security of the network between differing VLANs.

Where the first network traffic policy defines valid network traffic between SGTs, the system may determine if the first SGT associated with first device and the second SGT associated with the second device by comparing the first SGT and the second SGT to the policy's combinations of valid network traffic SGT's. For example, upon the system identifying a match, the system may determine that the network traffic between the first device and the second device is valid. For instance, upon identifying a match, the system may determine whether the SGT combination in the policy matches the SGT combination of the first and second device. If there is a match, the system verifies that the network traffic between the first device and the second device is valid.

In some embodiments, the system may determine whether network traffic between the first device and the second device is valid based on gateway-address-based network traffic policies. For example, as gateway-addresses may be associated with layer three network routers that route communication between one or more VLANs, a policy may indicate whether devices of given VLANs may communicate with one another based on the gateway address associated with the devices.

For instance, upon obtaining the respective device profiles for the first device and the second device, the system may determine, based on the first network traffic policy (e.g., where the first network traffic policy indicates gateway-address-based valid network traffic), the system may determine whether network traffic between a device being associated with the first gateway address and a device being associated with the second gateway address is valid. For example, the system may compare the first gateway address (e.g., associated with the first device) and the second gateway address (associated with the second device) to gateway-address combinations of valid network traffic as defined in the policy. For instance, if the first gateway address matches a gateway address that is part of the policy, the second gateway address matches a gateway address that is part of the policy, and the policy indicates that the first and second gateway address are permitted to communicate with one another, the system may then determine that devices communicating between the first and second gateway addresses is indeed permitted, or otherwise “valid” network traffic. As such, the system may then verify that the network traffic between the first device and the second device is valid. In this way, the system may verify whether network traffic between two devices that use respective gateways are permitted—thereby further enhancing cybersecurity measures of the computing network.

In some embodiments, the system may determine whether network traffic between the first device and the second device is valid based on gateway-address-based network traffic policies. For example, as gateway-addresses may be associated with layer three network routers that route communication between one or more VLANs, a policy may indicate whether devices of given VLANs may communicate with one another based on the gateway address associated with the devices.

For instance, upon obtaining the respective device profiles for the first device and the second device, the system may determine, based on the first network traffic policy (e.g., where the first network traffic policy indicates gateway-address-based valid network traffic), the system may determine whether network traffic between a device being associated with the first gateway address and a device being associated with the second gateway address is valid. For example, the system may compare the first gateway address (e.g., associated with the first device) and the second gateway address (associated with the second device) to gateway-address combinations of valid network traffic as defined in the policy. For instance, if the first gateway address matches a gateway address that is part of the policy, the second gateway address matches a gateway address that is part of the policy, and the policy indicates that the first and second gateway address are permitted to communicate with one another, the system may then determine that devices communicating between the first and second gateway addresses is indeed permitted, or otherwise “valid” network traffic. As such, the system may then verify that the network traffic between the first device and the second device is valid. In this way, the system may verify whether network traffic between two devices that use respective gateways are permitted—thereby further enhancing cybersecurity measures of the computing network.

In some embodiments, the system may determine whether network traffic between the first device and the second device is valid based on MAC-address-based network traffic policies. For example, while other validations that are possible with respect to the network traffic policies, there may be scenarios where a particular device of a particular VLAN is not to communicate with a particular device of another VLAN. To provide device-level cybersecurity enhancements, the system may determine, based on MAC addresses associated with the first and second devices, whether network traffic between the first and second devices are permitted or otherwise approved/valid.

For instance, upon obtaining the respective device profiles for the first device and the second device, the system may determine, based on the first network traffic policy (e.g., where the first network traffic policy indicates MAC-address-based valid network traffic), the system may determine, whether network traffic is valid based on the first MAC address and the second MAC address. For example, the first network traffic policy may include a list of MAC addresses of devices that are part of the computing network that are not to communicate with each other. For example, the MAC addresses indicated in the first network traffic policy may be a combination of two or more MAC addresses with an indication that such MAC addresses comprise invalid network traffic. In this way, the system may reduce the amount of computer memory resources required to store each “permitted” or otherwise valid network traffic MAC address combinations.

In such an embodiment, the system may parse the first network traffic to determine a match between the first MAC address and the second MAC address (e.g., as determined from the respective device profiles) to an instance of the first MAC address and an instance of the second MAC address as part of the first network traffic policy. Where a match fails to be located, the system may verify that the network traffic between the first device and the second device is valid (e.g., as the respective combination is not part of the list of invalid network traffic MAC address combinations). Alternatively, where the first network traffic policy indicates valid network traffic MAC address combinations, upon identifying a match, the system then verifies that the network traffic between the first device and the second device is valid.

At step 414, process 400 (e.g., using one or more components described above) may forward the message to a gateway address. For example, in response to the network traffic between the first device and the second device being valid, the system may cause forwarding of the message to a gateway address associated with communicating with the second device. For example, the gateway address may be an address that enables communication with the second device. For instance, the gateway address may be an IP address of a router associated with the second device. In this way, where multiple routers are used, the system may forward the message to a router that is able to route the message to the second device. In some embodiments, however, where the router that verified the network traffic as being valid between the first and second device, the router may forward the message to the second device. For instance, the gateway address may be the IP address assigned to the second device, the MAC address associated with the second device, or the IP address associated with the router itself to successfully forward the message to the second device. By doing so, the system may force inter-VLAN communications through a router to be received at the second device, thereby improving cybersecurity of inter-VLAN communications (e.g., as opposed to simply relying on a network switch to forward the message).

In some embodiments, the gateway address may be associated with a gateway device that is configured to forward messages from the first VLAN to the second VLAN. For example, in order to facilitate segmented, secure layer two communications, the system may use a gateway device to enable network traffic between two or more VLANs. For instance, the gateway device may be a layer three router that has an IP address. For example, the IP address may be used to receive messages from the computing network to forward the message to the intended VLAN hosting an intended destination device, or other devices.

As described above, to enhance cybersecurity of a computing network implementing multiple, segmented VLANS, as opposed to traditional architecture that allows network switches that may technically be part of two or more VLANS from simply forwarding messages to the respective devices, the unique system as described herein offers additional cybersecurity benefits by validating whether the network traffic between devices of different VLANS are in fact “allowed,” “permitted,” or otherwise valid. By doing so, the system adds a second layer of security to the computing network while being able to properly segment devices of the computing network into their respective categories.

In some embodiments, the managing firewall may be hosted on the gateway device. For example, the managing firewall may be a firewall that is implemented on the layer three router. The layer three router may receive the forwarded message (e.g., from the first device) and may provide the forwarded message to the managing firewall. In response to the managing firewall verifying that the network traffic between the first device and the second device is valid, the gateway device may determine the gateway address associated with communicating with the second device. For example, the gateway address may be an IP address associated with the second device. As such, the gateway address may forward the message to the determined gateway address associated with communicating with the gateway address. By doing so, the system may reduce the amount of network traffic experienced by centralized firewalls that are traditionally implemented at a datacenter core.

Moreover, in some embodiments where the gateway device is located at a Wide Area Network (WAN) edge (e.g., as part of the VLANs of the system as opposed to at the center of a WAN, the system may further enhance cyber security of the WAN itself by preventing unauthorized traffic from accessing the WAN edges.

In some embodiments, the system may receive a command to permit forwarding of messages irrespective of assigned SGTs at one or more ports. For example, a user may submit a command to one or more network switches to permit forwarding of messages regardless of which SGT/VLANs are assigned to the ports. For instance, where the network switches are configured (e.g., based on the configuration profile) to prevent messages from being forwarded to devices that are part of the same VLAN, where a network engineer wants the network to operate as a natural VLAN, the network engineer may submit the command. By doing so, the configuration profile of the one or more network switches may be updated to incorporate forwarding of messages irrespective of assigned SGTs at ports of the network switch. In this way, the network switches may be dynamically configured to operate as a natural VLAN (e.g., where each device that is part of a given VLAN is able to freely communicate with other devices that are part of the same VLAN).

In such a configuration, the system may receive a message from a first device at a first port mapped to a first VLAN. For example, a network switch may receive the message from a first device at the network switch's first port that is associated with a first VLAN. The system may then insert, based on receiving the message at the first port mapped to the first VLAN, the first SGT into the message. The system may then determine, based on a destination address of the message (e.g., DMAC), a second port to forward the second message such that is received by the second device. In response to determining, based on an assigned SGT to the second port (e.g., similar to that as described above), that the first VLAN is different from the second VLAN, the system may forward the second message, via the second port, to the managing firewall to verify whether the first device is allowed to communicate with the second device (e.g., verify whether the network traffic between the first device and the second device is valid). In this way, the system may provide a layer of cybersecurity between the respective VLANs. However, in response to determining that the first VLAN is the same as the second VLAN, the system may forward the message, via the second port, to the destination address of the message. For example, due to the network switch's updated configuration profile, the network switch may act in its natural form leveraging VLAN technology, to enable the first device and the second device to communicate directly with one another via the network switch.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a message, from a first device, at a first port mapped to a first VLAN, to communicate with a second device, the message comprising a first address associated with the first device and a second address associated with the second device; inserting, based on receiving the message at the first port mapped to the first VLAN, a SGT that is assigned to the first port into the message; determining, based on the second address of the message, a second port to forward the message to be received by the second device, the second port being mapped to a second VLAN; in response to determining, based on an assigned SGT to the second port, that the second VLAN is different than the first VLAN: forwarding the message, via the second port, to a managing firewall in lieu of preventing forwarding of the message based on the second VLAN being the same as the first VLAN; verifying, at the managing firewall, based on one or more network traffic policies, that network traffic between the first device and the second device is valid; and in response to verifying that the network traffic between the first device and the second device is valid, causing forwarding of the message to a gateway address associated with communicating with the second device.
2. The method of any one of the preceding embodiments, wherein verifying, at the managing firewall, that the network traffic between the first device and the second device is valid further comprises: obtaining, at the managing firewall, a first network traffic policy of the one or more network traffic policies indicating that network traffic between known devices is valid; extracting, at the managing firewall, from the message, the first address associated with the first device and the second address associated with the second device; determining, at the managing firewall, whether a first device profile corresponding to the first device and a second device profile corresponding to the second device exist by accessing a database storing device profiles, wherein the access of the database is based on the extracted first address and second address, respectively, and wherein the existence of the first device profile and the second device profile indicate that the first device and the second devices are known devices; and in response to determining that the first device profile and the second device profile exist, verifying that the network traffic between the first device and the second device is valid.
3. The method of any one of the preceding embodiments, wherein verifying, at the managing firewall, that network traffic between the first device and the second device is valid further comprises: obtaining, at the managing firewall, a first network traffic policy of the one or more network traffic policies indicating SGT-based valid network traffic; extracting, at the managing firewall, from the message, the first address associated with the first device and the second address associated with the second device; obtaining, at the managing firewall, by accessing a database based on the extracted first address and the second address, a first device profile corresponding to the first device and a second device profile corresponding to the second device, respectively, wherein the first device profile comprises a first SGT corresponding to the first device and the second device profile comprise a second SGT corresponding to the second device; determining, based on the first network traffic policy, whether network traffic between a device being associated with the first SGT and a device being associated with the second SGT is valid; and in response to determining that network traffic between a device being associated with the first SGT and a device being associated with the second SGT is valid, verifying that the network traffic between the first device and the second device is valid.
4. The method of any one of the preceding embodiments, wherein verifying, at the managing firewall, that network traffic between the first device and the second device is valid further comprises: obtaining, at the managing firewall, a first network traffic policy of the one or more network traffic policies indicating directional-SGT-based valid network traffic; extracting, at the managing firewall, from the message, the first address associated with the first device and the second address associated with the second device; obtaining, at the managing firewall, by accessing a database based on the extracted first address and the second address, a first device profile corresponding to the first device and a second device profile corresponding to the second device, respectively, wherein the first device profile comprises a first SGT corresponding to the first device and the second device profile comprise a second SGT corresponding to the second device; determining, based on the first network traffic policy, whether network traffic between a device being associated with the first SGT and a device being associated with the second SGT is directionally-valid; and in response to determining that network traffic between a device being associated with the first SGT and a device being associated with the second SGT is directionally-valid, verifying that the network traffic between the first device and the second device is valid.
5. The method of any one of the preceding embodiments, further comprising: obtaining, at the managing firewall, a first network traffic policy of the one or more network traffic policies indicating gateway-address-based valid network traffic; extracting, at the managing firewall, from the message, the first address associated with the first device and the second address associated with the second device; obtaining, at the managing firewall, by accessing a database based on the extracted first address and the second address, a first device profile corresponding to the first device and a second device profile corresponding to the second device, respectively, wherein the first device profile comprises a first gateway address corresponding to the first device and the second device profile comprise a second gateway address corresponding to the second device; determining, based on the first network traffic policy, whether network traffic between a device being associated with the first gateway address and a device being associated with the second gateway address is valid; and in response to determining that network traffic between a device being associated with the first gateway address and a device being associated with the second gateway address is valid, verifying that the network traffic between the first device and the second device is valid.
6. The method of any one of the preceding embodiments, further comprising: obtaining, at the managing firewall, a first network traffic policy of the one or more network traffic policies indicating MAC-address-based valid network traffic; extracting, at the managing firewall, from the message, the first address associated with the first device and the second address associated with the second device; obtaining, at the managing firewall, by accessing a database based on the extracted first address and the second address, a first device profile corresponding to the first device and a second device profile corresponding to the second device, respectively, wherein the first device profile comprises a first MAC address corresponding to the first device and the second device profile comprise a second MAC address corresponding to the second device; determining, based on the first network traffic policy, whether network traffic between the first device and the second device is valid based on the first MAC address and the second MAC address, respectively; and in response to determining that network traffic between the first device and the second device is valid based on the first MAC address and the second MAC address, verifying that the network traffic between the first device and the second device is valid.
7. The method of any one of the preceding embodiments, wherein prior to receiving the message from the first device, the method further comprises: receiving an access-request message, from a third device, at a third port mapped to a third VLAN, the access-request message comprising a third address associated with the third device; forwarding the access-request message to the managing firewall to generate a third device profile corresponding to the third device, wherein the third device profile comprises (i) a third SGT corresponding to a SGT assigned to the third port, (ii) a VLAN identifier corresponding to the third VLAN, (iii) a gateway address corresponding to the third VLAN, and (iv) a Media Access Control (MAC) address of the third device; and storing, by the managing firewall, the third device profile in a database associated with the managing firewall, wherein the storing of the third device profile is an indication that the third device is onboarded to the third VLAN, and wherein the third device is the first device, and the third VLAN is the first VLAN.
8. The method of any one of the preceding embodiments, wherein inserting the SGT that is assigned to the first port into the message comprises: identifying a SGT portion of a set of portions of the message; determining a SGT that is assigned to the first port based on a configuration profile associated with a set of ports; and inserting the determined SGT into the message at the SGT portion.
9. The method of any one of the preceding embodiments, wherein the first port and the second port are part of a network switch that is part of both (i) the first VLAN and (ii) the second VLAN.
10. The method of any one of the preceding embodiments, wherein the network switch is configured to automatically deny network traffic involving two devices that are associated with the same SGT.
11. The method of any one of the preceding embodiments, wherein the gateway address associated with communicating with the second device is associated with a gateway device that is configured to forward messages from the first VLAN to the second VLAN.
12. The method of any one of the preceding embodiments, further comprising: receiving the forwarded message at the gateway device; providing, by the gateway device, the forwarded message to the managing firewall, the managing firewall being hosted on the gateway device; in response to the verifying that the network traffic between the first device and the second device is valid, determining, by the gateway device, the gateway address associated with communicating with the second device; and causing the forwarding of the message to the determined gateway address.
13. The method of any one of the preceding embodiments, further comprising: receiving a first Dynamic Host Configuration Protocol (DHCP) Reserved IP address from a DHCP server for the first device; determining the first address based on the first DHCP Reserved IP address; receiving a second DCHP Reserved IP address from a DHCP server for the second device; and determining the second address based on the second DHCP Reserved IP address.
14. The method of any one of the preceding embodiments, further comprising: identifying a first Media Access Control (MAC) address of the first device; determining the first address based on the first MAC address; identifying a second MAC address of the second device; and determining the second address based on the second MAC address.
15. The method of any one of the preceding embodiments, further comprising: receiving a command to permit forwarding of messages irrespective of assigned SGTs at either the first port or the second port; and updating, based on the command, a configuration profile to incorporate forwarding of messages irrespective of assigned SGTs at either the first port or the second port.
16. The method of any one of the preceding embodiments, further comprising: receiving a second message, from the first device, at the first port mapped to the first VLAN, to communicate with the second device, the second message comprising the first address associated with the first device and the second address associated with the second device; inserting, based on receiving the second message at the first port mapped to the first VLAN, the first SGT into the second message; determining, based on the second address of the message, the second port to forward the second message to be received by the second device, the second port being mapped to the second VLAN; and in response to determining, based on the assigned SGT to the second port, that the second VLAN is different than that of the first VLAN, forwarding of the second message, via the second port, to the managing firewall to verify whether the first device is allowed to communicate with the second device.
17. The method of any one of the preceding embodiments, further comprising: receiving a second message, from the first device, at the first port mapped to the first VLAN, to communicate with the second device, the second message comprising the first address associated with the first device and the second address associated with the second device; inserting, based on receiving the second message at the first port mapped to the first VLAN, the first SGT into the second message; determining, based on the second address of the message, the second port to forward the second message to be received by the second device, the second port being mapped to the second VLAN; and in response to determining, based on the assigned SGT to the second port, that the second VLAN is the same as the first VLAN, forwarding of the message, via the second port, to the second address of the message.
18. One or more non-transitory, computer-readable mediums storing instructions that, when executed by a data processing apparatus, cause the data processing apparatus to perform operations comprising those of any of embodiments 1-17.
19. A system comprising one or more processors; and memory storing instructions that, when executed by the processors, cause the processors to effectuate operations comprising those of any of embodiments 1-17.
21. A system comprising means for performing any of embodiments 1-17.

What is claimed is:

1. A system for reducing data storage requirements associated with facilitating secure, scalable, segmented layer two communications, the system comprising:
a first set of computing devices that are part of a first Virtual Local Area Network (VLAN) that is associated with a first Security Group Tag (SGT);
a second set of computing devices that are part of a second VLAN that is associated with a second SGT, wherein the first SGT is different from the second SGT;
a managing firewall comprising (i) one or more network traffic policies indicating valid and invalid network traffic communications between computing devices and (ii) device profiles;
one or more processors and non-transitory computer-readable media comprising instructions that, when executed by the one or more processors, cause operations comprising:
receiving a communication request, from a first computing device, at a first dynamically configured port mapped to the first VLAN, to communicate with a second computing device, the communication request comprising a source address associated with the first computing device and a destination address associated with the second computing device;
inserting, based on receiving the communication request at the first dynamically configured port mapped to the first VLAN, the first SGT into the communication request;
determining, based on the destination address of the communication request, a second port to forward the communication request to be received by the second computing device, the second port being mapped to a third VLAN;
in response to determining, based on an assigned SGT to the second port, that the third VLAN is the first VLAN:
preventing forwarding of the communication request, via the second port, in lieu of forwarding the communication request to the managing firewall to verify whether the network traffic communication between the first computing device and the second computing device is valid;
in response to determining, based on the assigned SGT to the second port, that the third VLAN is the second VLAN:
forwarding the communication request, via the second port, to the managing firewall;
verifying, at the managing firewall, based on (i) the one or more network traffic policies and (ii) a first device profile corresponding to the first computing device and a second device profile corresponding to the second computing device, that the network traffic communication between the first computing device and the second computing device is valid; and
in response to the network traffic communication between the first computing device and the second computing device being valid, causing forwarding the communication request to a gateway address associated with communicating with the second computing device.

2. A method for reducing data storage requirements associated with facilitating secure, scalable, segmented layer two communications, the method comprising:
receiving a message, from a first device, at a first port mapped to a first Virtual Local Area Network (VLAN), to communicate with a second device, the message comprising a first address associated with the first device and a second address associated with the second device;
inserting, based on receiving the message at the first port mapped to the first VLAN, a Security Group Tag (SGT) that is assigned to the first port into the message;
determining, based on the second address of the message, a second port to forward the message to be received by the second device, the second port being mapped to a second VLAN;
in response to determining, based on an assigned SGT to the second port, that the second VLAN is different than the first VLAN:
forwarding the message, via the second port, to a managing firewall in lieu of preventing forwarding of the message based on the second VLAN being the same as the first VLAN;
verifying, at the managing firewall, based on one or more network traffic policies, that network traffic between the first device and the second device is valid; and
in response to the verifying that the network traffic between the first device and the second device is valid, causing forwarding of the message to a gateway address associated with communicating with the second device.

3. The method of claim 2, wherein verifying, at the managing firewall, that the network traffic between the first device and the second device is valid further comprises:
obtaining, at the managing firewall, a first network traffic policy of the one or more network traffic policies indicating that network traffic between known devices is valid;
extracting, at the managing firewall, from the message, the first address associated with the first device and the second address associated with the second device;
determining, at the managing firewall, whether a first device profile corresponding to the first device and a second device profile corresponding to the second device exist by accessing a database storing device profiles, wherein the access of the database is based on the extracted first address and second address, respectively, and wherein the existence of the first device profile and the second device profile indicate that the first device and the second devices are known devices; and
in response to determining that the first device profile and the second device profile exist, verifying that the network traffic between the first device and the second device is valid.

4. The method of claim 2, wherein verifying, at the managing firewall, that network traffic between the first device and the second device is valid further comprises:
obtaining, at the managing firewall, a first network traffic policy of the one or more network traffic policies indicating SGT-based valid network traffic;
extracting, at the managing firewall, from the message, the first address associated with the first device and the second address associated with the second device;
obtaining, at the managing firewall, by accessing a database based on the extracted first address and the second address, a first device profile corresponding to the first device and a second device profile corresponding to the second device, respectively, wherein the first device profile comprises a first SGT corresponding to the first device and the second device profile comprise a second SGT corresponding to the second device;
determining, based on the first network traffic policy, whether network traffic between a device being associated with the first SGT and a device being associated with the second SGT is valid; and
in response to determining that network traffic between a device being associated with the first SGT and a device being associated with the second SGT is valid, verifying that the network traffic between the first device and the second device is valid.

5. The method of claim 2, wherein verifying, at the managing firewall, that network traffic between the first device and the second device is valid further comprises:
obtaining, at the managing firewall, a first network traffic policy of the one or more network traffic policies indicating directional-SGT-based valid network traffic;
extracting, at the managing firewall, from the message, the first address associated with the first device and the second address associated with the second device;
obtaining, at the managing firewall, by accessing a database based on the extracted first address and the second address, a first device profile corresponding to the first device and a second device profile corresponding to the second device, respectively, wherein the first device profile comprises a first SGT corresponding to the first device and the second device profile comprise a second SGT corresponding to the second device;
determining, based on the first network traffic policy, whether network traffic between a device being associated with the first SGT and a device being associated with the second SGT is directionally-valid; and
in response to determining that network traffic between a device being associated with the first SGT and a device being associated with the second SGT is directionally-valid, verifying that the network traffic between the first device and the second device is valid.

6. The method of claim 2, further comprising:
obtaining, at the managing firewall, a first network traffic policy of the one or more network traffic policies indicating gateway-address-based valid network traffic;
extracting, at the managing firewall, from the message, the first address associated with the first device and the second address associated with the second device;
obtaining, at the managing firewall, by accessing a database based on the extracted first address and the second address, a first device profile corresponding to the first device and a second device profile corresponding to the second device, respectively, wherein the first device profile comprises a first gateway address corresponding to the first device and the second device profile comprise a second gateway address corresponding to the second device;
determining, based on the first network traffic policy, whether network traffic between a device being associated with the first gateway address and a device being associated with the second gateway address is valid; and
in response to determining that network traffic between a device being associated with the first gateway address and a device being associated with the second gateway address is valid, verifying that the network traffic between the first device and the second device is valid.

7. The method of claim 2, further comprising:
obtaining, at the managing firewall, a first network traffic policy of the one or more network traffic policies indicating MAC-address-based valid network traffic;
extracting, at the managing firewall, from the message, the first address associated with the first device and the second address associated with the second device;
obtaining, at the managing firewall, by accessing a database based on the extracted first address and the second address, a first device profile corresponding to the first device and a second device profile corresponding to the second device, respectively, wherein the first device profile comprises a first MAC address corresponding to the first device and the second device profile comprise a second MAC address corresponding to the second device;
determining, based on the first network traffic policy, whether network traffic between the first device and the second device is valid based on the first MAC address and the second MAC address, respectively; and
in response to determining that network traffic between the first device and the second device is valid based on the first MAC address and the second MAC address, verifying that the network traffic between the first device and the second device is valid.

8. The method of claim 2, wherein prior to receiving the message from the first device, the method further comprises:
receiving an access-request message, from a third device, at a third port mapped to a third VLAN, the access-request message comprising a third address associated with the third device;
forwarding the access-request message to the managing firewall to generate a third device profile corresponding to the third device, wherein the third device profile comprises (i) a third SGT corresponding to a SGT assigned to the third port, (ii) a VLAN identifier corresponding to the third VLAN, (iii) a gateway address corresponding to the third VLAN, and (iv) a Media Access Control (MAC) address of the third device; and
storing, by the managing firewall, the third device profile in a database associated with the managing firewall, wherein the storing of the third device profile is an indication that the third device is onboarded to the third VLAN, and wherein the third device is the first device, and the third VLAN is the first VLAN.

9. The method of claim 2, wherein inserting the SGT that is assigned to the first port into the message comprises:
identifying a SGT portion of a set of portions of the message;
determining a SGT that is assigned to the first port based on a configuration profile associated with a set of ports; and
inserting the determined SGT into the message at the SGT portion.

10. The method of claim 2, wherein the first port and the second port are part of a network switch that is part of both (i) the first VLAN and (ii) the second VLAN.

11. The method of claim 10, wherein the network switch is configured to automatically deny network traffic involving two devices that are associated with the same SGT.

12. The method of claim 2, wherein the gateway address associated with communicating with the second device is associated with a gateway device that is configured to forward messages from the first VLAN to the second VLAN.

13. The method of claim 12, further comprising:
receiving the forwarded message at the gateway device;
providing, by the gateway device, the forwarded message to the managing firewall, the managing firewall being hosted on the gateway device;
in response to the verifying that the network traffic between the first device and the second device is valid, determining, by the gateway device, the gateway address associated with communicating with the second device; and
causing the forwarding of the message to the determined gateway address.

14. The method of claim 2, further comprising:
receiving a first Dynamic Host Configuration Protocol (DHCP) Reserved IP address from a DHCP server for the first device;
determining the first address based on the first DHCP Reserved IP address;
receiving a second DCHP Reserved IP address from a DHCP server for the second device; and
determining the second address based on the second DHCP Reserved IP address.

15. The method of claim 2, further comprising:
identifying a first Media Access Control (MAC) address of the first device;
determining the first address based on the first MAC address;
identifying a second MAC address of the second device; and
determining the second address based on the second MAC address.

16. One or more non-transitory computer-readable media comprising instructions that, when executed by one or more processors, cause operations comprising:
receiving a message, from a first device, at a first port mapped to a first Virtual Local Area Network (VLAN), to communicate with a second device, the message comprising a first address associated with the first device and a second address associated with the second device;
inserting, based on receiving the message at the first port mapped to the first VLAN, a first Security Group Tag (SGT) into the message;
determining, based on the second address of the message, a second port to forward the message to be received by the second device, the second port being mapped to a second VLAN; and
in response to determining, based on an assigned SGT to the second port, that the second VLAN is the same as the first VLAN, preventing forwarding of the message, via the second port, in lieu of forwarding the message a managing firewall to verify whether the first device is allowed to communicate with the second device.

17. The media of claim 16, wherein the instructions that, when executed by the one or more processors, further cause operations comprising:
receiving a command to permit forwarding of messages irrespective of assigned SGTs at either the first port or the second port; and
updating, based on the command, a configuration profile to incorporate forwarding of messages irrespective of assigned SGTs at either the first port or the second port.

18. The media of claim 17, wherein the instructions that, when executed by the one or more processors, further cause operations comprising:
receiving a second message, from the first device, at the first port mapped to the first VLAN, to communicate with the second device, the second message comprising the first address associated with the first device and the second address associated with the second device;
inserting, based on receiving the second message at the first port mapped to the first VLAN, the first SGT into the second message;
determining, based on the second address of the message, the second port to forward the second message to be received by the second device, the second port being mapped to the second VLAN; and
in response to determining, based on the assigned SGT to the second port, that the second VLAN is different than that of the first VLAN, forwarding of the second message, via the second port, to the managing firewall to verify whether the first device is allowed to communicate with the second device.

19. The media of claim 17, wherein the instructions that, when executed by the one or more processors, further cause operations comprising:
receiving a second message, from the first device, at the first port mapped to the first VLAN, to communicate with the second device, the second message comprising the first address associated with the first device and the second address associated with the second device;
inserting, based on receiving the second message at the first port mapped to the first VLAN, the first SGT into the second message;
determining, based on the second address of the message, the second port to forward the second message to be received by the second device, the second port being mapped to the second VLAN; and
in response to determining, based on the assigned SGT to the second port, that the second VLAN is the same as the first VLAN, forwarding of the message, via the second port, to the second address of the message.

20. The media of claim 16, wherein inserting the SGT that is assigned to the first port into the message comprises:
identifying a SGT portion of a set of portions of the message;
determining a SGT that is assigned to the first port based on a configuration profile associated with a set of ports; and
inserting the determined SGT into the message at the SGT portion.
